(19) United States
(12) Patent Application Publication
(10) Pub. No.: US 2026/0024812 A1
(43) Pub. Date: Jan. 22, 2026

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: HYUNBONG CHOI, Yongin-si (KR); Yeji YANG, Yongin-si (KR); Sangwoo PARK, Yongin-si (KR); Hongryeol PARK, Yongin-si (KR); Youngkyeong SHIN, Yongin-si (KR); Dasol JUN, Yongin-si (KR); Sohee KIM, Yongin-si (KR); Woojung JI, Yongin-si (KR); SANGHOON KIM, Yongin-si (KR)

(21) Appl. No.: 19/093,065

(22) Filed: Mar. 27, 2025

(30) Foreign Application Priority Data
Jul. 19, 2024 (KR) 10-2024-0095636

(51) Int. Cl. H01M 10/0567; H01M 4/02; H01M 4/36; H01M 4/38; H01M 4/525; H01M 4/58; H01M 4/583; H01M 10/0525; H01M 10/0568; H01M 10/0569

(52) U.S. Cl. CPC H01M 10/0567; H01M 4/362; H01M 4/386; H01M 4/525; H01M 4/5825; H01M 4/583; H01M 10/0525; H01M 10/0568; H01M 10/0569; H01M 2004/027; H01M 2004/028; H01M 2300/004

(57) ABSTRACT

Electrolytes and rechargeable lithium batteries are disclosed. The electrolyte includes a non-aqueous organic solvent, a lithium salt, a first additive represented by Chemical Formula 1, and a second additive represented by Chemical Formula 2.

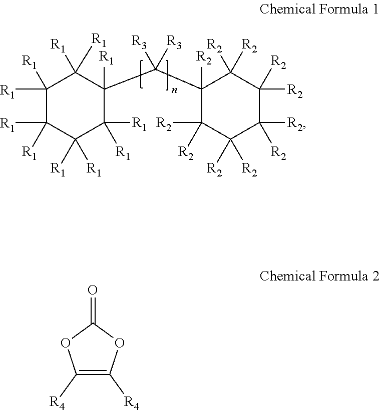

### CROSS-REFERENCE TO RELATED APPLICATION

The present application claims priority to and the benefit of Korean Patent Application No. 10-2024-0095636, filed on Jul. 19, 2024, in the Korean Intellectual Property Office, the entire disclosure of which is incorporated herein by reference.

### BACKGROUND

### 1. Field

One or more embodiments of the present disclosure relate to an electrolyte for a rechargeable lithium battery and a rechargeable lithium battery including the electrolyte.

### 2. Description of the Related Art

Recently, with the rapid spread and popularization of electronic devices that uses batteries (such as mobile phones and/or laptop computers), as well as electric vehicles, there is a rapidly growing demand for such batteries, for example, rechargeable batteries, with relatively high energy density and high capacity. Accordingly, intensive research has been conducted to improve performance of such rechargeable batteries, e.g., rechargeable lithium batteries.

A rechargeable lithium battery includes a positive electrode, a negative electrode, and an electrolyte. The positive and negative electrodes each include an active material capable of intercalation and deintercalation of lithium ions. Electrical energy is produced (generated) via oxidation and reduction reactions if (e.g., when) lithium ions are intercalated and deintercalated. For example, lithium ions are intercalated into the positive electrode and/or deintercalated from the negative electrode during the discharge process.

A lithium salt dissolved in a non-aqueous organic solvent is used as the electrolyte of the rechargeable lithium battery. The characteristics of the rechargeable lithium battery are achieved through complex reactions between the positive electrode and the electrolyte, as well as between the negative electrode and the electrolyte. Therefore, the use of an appropriate or suitable electrolyte is an importance variable for the improvement of the rechargeable lithium battery.

### SUMMARY

One or more aspects of embodiments of the present disclosure are directed toward an electrolyte that increases cycle life characteristics of a rechargeable lithium battery at a high-temperature environment and improves suppression of resistance increase (e.g., reduces the increase in resistance).

One or more aspects of embodiments of the present disclosure are directed toward an electrolyte that suppresses gas generation if (e.g., when) a rechargeable lithium battery including the electrolyte is left at high temperatures.

One or more aspects of embodiments of the present disclosure are directed toward a rechargeable lithium battery including the electrolyte.

Additional aspects will be set forth in part in the description which follows and, in part, will be apparent from the description, or may be learned by practice of the presented embodiments of the disclosure.

According to one or more embodiments of the present disclosure, an electrolyte for a rechargeable lithium battery may include: a non-aqueous organic solvent; a lithium salt; a first additive represented by Chemical Formula 1; and a second additive represented by Chemical Formula 2.

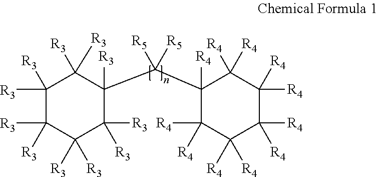

In Chemical Formula 1,
R₁ may be identical to or different from one another and may each independently be hydrogen, a halogen, a C1 to C10 alkyl group, or an isocyanate group, wherein at least one selected from among R₁(s) is an isocyanate group,
R₂ may be identical to or different from one another and may each independently be hydrogen, a halogen, a C1 to C10 alkyl group, or an isocyanate group, wherein at least one selected from among R₂(s) is an isocyanate group,
R₃ may be identical to or different from each other and may each independently be hydrogen or a cyclohexyl isocyanate residue, and
n may be an integer of 1 to 10.

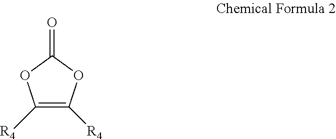

In Chemical Formula 2,
R₄ may be identical to or different from each other and may each independently be hydrogen, a halogen, a cyano (CN) group, a nitro (NO₂) group, or a C1 to C5 alkyl group.

According to one or more embodiments of the present disclosure, a rechargeable lithium battery may include: a positive electrode that includes a positive electrode active material; a negative electrode that includes a negative electrode active material; and the electrolyte for a rechargeable lithium battery.

### BRIEF DESCRIPTION OF DRAWINGS

The accompanying drawings are included to provide a further understanding of the present disclosure, and are incorporated in and constitute a part of this disclosure. The drawings illustrate example embodiments of the present disclosure and, together with the description, serve to explain principles of the present disclosure. The above and other aspects, features, and advantages of certain embodiments of the present disclosure will be more apparent from the following description taken in conjunction with the accompanying drawings.

FIG. 1 illustrates a simplified conceptual diagram showing a rechargeable lithium battery according to one or more embodiments of the present disclosure.

FIGS. 2-5 each illustrate a diagram showing a rechargeable lithium battery according to one or more embodiments of the present disclosure.

### DETAILED DESCRIPTION

In order to sufficiently understand the configurations and effects of the present disclosure, one or more embodiments of the present disclosure will be described with reference to the accompanying drawings. It should be noted, however, that the present disclosure is not limited to the following example embodiments, and may be implemented in one or more other suitable forms. Rather, the example embodiments are provided only to illustrate the present disclosure and assist those skilled in the art to fully know the scope of the disclosure.

In the present disclosure, it will be understood that, if (e.g., when) an element is referred to as being on another element, the element may be directly on the other element or one or more intervening elements may be present therebetween. In contrast, if (e.g., when) an element is referred to as being “directly on” another element, there are no intervening elements present. In the drawings, thicknesses of some components may be exaggerated for effectively explaining the technical contents. Like reference numerals refer to like elements throughout the present disclosure, and duplicative descriptions thereof may not be provided for conciseness.

Unless otherwise specially noted in this disclosure, the expression of singular form may include the expression of plural form. For example, the singular forms “a,” “an,” and “the” are intended to include the plural forms as well, unless the context clearly indicates otherwise. In addition, unless otherwise specially noted, the phrase “A or B” or “A and/or” or “A/B” may indicate “A but not B,” “B but not A,” and “A and B,” The terms “comprise(s)/include(s)” and/or “comprising/including” and/or “have(has)/having” used in this disclosure do not exclude the presence or addition of one or more other components. Further, the utilization of “may” when describing embodiments of the present disclosure refers to “one or more embodiments of the present disclosure”.

As used herein, the term “combination thereof” may refer to a mixture, a stack, a composite, a copolymer, an alloy, a blend, or a reaction product of the constituents.

In the present disclosure, unless otherwise separately defined, the term “substituted” may refer to that at least one hydrogen of a substituent or a compound is substituted by deuterium, a halogen, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, and/or a (e.g., any suitable) combination thereof.

In more detail, the term “substituted” may refer to that at least one hydrogen of a substituent or a compound is substituted by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, in one or more embodiments, the term “substituted” may refer to that at least one hydrogen of a substituent or a compound is substituted by deuterium, a halogen, a C1 to C20 alkyl group, a C6 to C30 aryl group, a C1 to C10 fluoroalkyl group, or a cyano group. In one or more embodiments, the term “substituted” may refer to that at least one hydrogen of a substituent or a compound is substituted by deuterium, a halogen, a C1 to C5 alkyl group, a C6 to C18 aryl group, a C1 to C5 fluoroalkyl group, or a cyano group. For example, the term “substituted” may refer to that at least one hydrogen of a substituent or a compound is substituted by deuterium, a cyano group, a halogen, a methyl group, an ethyl group, a propyl group, a butyl group, a phenyl group, a biphenyl group, a terphenyl group, a trifluoromethyl group, or a naphthyl group.

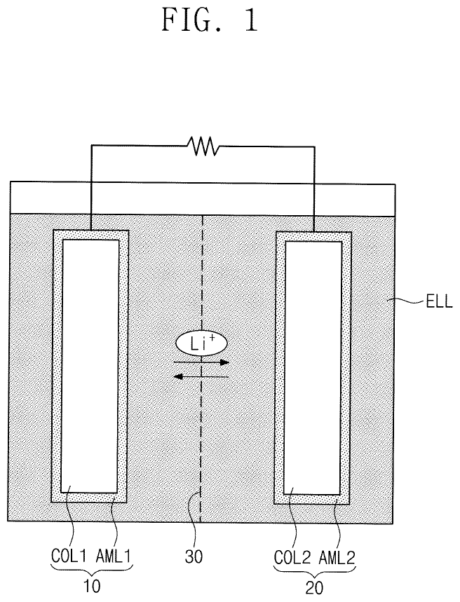

FIG. 1 illustrates a simplified conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. For example, the positive electrode 10, the negative electrode 20, and the separator 30 may be impregnated in and/or with the electrolyte ELL.

The electrolyte ELL may be a medium (e.g., an ion conductor) through which lithium ions are migrated and transferred between the positive electrode 10 and the negative electrode 20. In the electrolyte ELL, the lithium ions may move through the separator 30 toward one selected from among the positive electrode 10 and the negative electrode 20 (e.g., the lithium ions may move through the separator 30 toward either the positive electrode 10 or the negative electrode 20).

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material (e.g., in a form of particles) and may further include a binder and/or a conductive material (e.g., an electron conductor).

For example, the positive electrode 10 may further include an additive that can serve as a sacrificial positive electrode.

An amount of the positive electrode active material may be about 90 wt % to about 99.5 wt % relative to (i.e., based on) a total weight of 100 wt % of the positive electrode active material layer AML1. An amount of each of the binder and the conductive material may be in a range of about 0.5 wt % to about 5 wt % relative to (i.e., based on) the total weight of 100 wt % of the positive electrode active material layer AML1.

The binder may serve to improve attachment of positive electrode active material particles to each other and also to improve attachment of the positive electrode active material to the current collector COL1. The binder may include, for example, one or more selected from among polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but embodiments of the present disclosure are not limited thereto.

The conductive material (e.g., an electrically or electron conductive material or conductor) may be used to provide an electrode with conductivity, and any suitable conductive material that does not cause a chemical change in a battery may be used as the conductive material. The conductive material may include, for example, a carbon-based material such as natural graphite, artificial graphite, carbon black, acetylene black, Ketjen black, carbon fiber, carbon nano-fiber, and/or carbon nano-tube; a metal powder or metal fiber containing one or more selected from among copper, nickel, aluminum, and silver; a conductive polymer such as a polyphenylene derivative; and/or a (e.g., any suitable) mixture thereof.

In one or more embodiments, aluminum (Al) may be used as the current collector COL1, but embodiments of the present disclosure are not limited thereto.

### Positive Electrode Active Material

The positive electrode active material in the positive electrode active material layer AML1 may include a compound (e.g., lithiated intercalation compound) that may reversibly intercalate and deintercalate lithium. For example, in one or more embodiments, the positive electrode active material may include at least one kind of composite oxide including lithium and a metal that is selected from among cobalt, manganese, nickel, and/or a (e.g., any suitable) combination thereof.

The composite oxide may include lithium transition metal composite oxides, for example, lithium-nickel-based oxides, lithium-cobalt-based oxides, lithium-manganese-based oxides, lithium-iron-phosphate-based compounds, cobalt-free nickel-manganese-based oxides, and/or a (e.g., any suitable) combination thereof.

For example, in one or more embodiments, the positive electrode active material may include a compound represented by one selected from among chemical formulae: LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the foregoing chemical formulae, A may be nickel (Ni), cobalt (Co), manganese (Mn), or a (e.g., any suitable) combination thereof, X may be Al, Ni, Co, Mn, chromium (Cr), iron (Fe), magnesium (Mg), strontium (Sr), vanadium (V), a rare-earth element, or a (e.g., any suitable) combination thereof, D may be oxygen (O), fluorine (F), sulfur (S), phosphorous (P), or a (e.g., any suitable) combination thereof, G may be Al, Cr, Mn, Fe, Mg, lanthanum (La), cerium (Ce), Sr, V, or a (e.g., any suitable) combination thereof, and L¹ may be Mn, Al, or a (e.g., any suitable) combination thereof.

For example, in one or more embodiments, the positive electrode active material may be a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to (i.e., based on) 100 mol % of a total metal excluding lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material (e.g., in a form of particles) and may further include a binder and/or a conductive material (e.g., an electron conductor).

For example, in one or more embodiments, the negative electrode active material layer AML2 may include a negative electrode active material of about 90 wt % to about 99 wt %, a binder of about 0.5 wt % to about 5 wt %, and a conductive material of about 0 wt % to about 5 wt %, based on a total weight of 100 wt % of the negative electrode active material layer.

The binder may serve to improve attachment of negative electrode active material particles to each other and also to improve attachment of the negative electrode active material to the current collector COL2. The binder may include a non-aqueous (e.g., water-insoluble) binder, an aqueous (e.g., water-soluble) binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluoro elastomer, polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenolic resin, an epoxy resin, polyvinyl alcohol, and/or a (e.g., any suitable) combination thereof.

When an aqueous binder is used as the binder of the negative electrode, a cellulose-based compound capable of providing viscosity may further be included. The cellulose-based compound may include one or more selected from among carboxymethyl cellulose, hydroxypropylmethyl cellulose, methyl cellulose, and alkali metal salts thereof. The alkali metal may include Na, K, or Li.

The dry binder may include a fibrillizable polymer material, for example, polytetrafluoroethylene, polyvinylidene fluoride, a polyvinylidene fluoride-hexafluoropropylene copolymer, polyethylene oxide, and/or a (e.g., any suitable) combination thereof.

The conductive material (e.g., electrically or electron conductive material or conductor) may be used to provide an electrode with conductivity, and any suitable conductive material that does not cause a chemical change in a battery may be used as the conductive material. For example, in one or more embodiments, the conductive material may include a carbon-based material such as natural graphite, artificial graphite, carbon black, acetylene black, Ketjen black, carbon fiber, carbon nano-fiber, and/or carbon nano-tube; a metal powder or metal fiber including one or more selected from among copper, nickel, aluminum, and silver; a conductive polymer such as a polyphenylene derivative; and/or a (e.g., any suitable) mixture thereof.

The current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that may reversibly intercalate and deintercalate lithium ions, lithium metal, a lithium metal alloy, a material that may dope and de-dope lithium, or a transition metal oxide.

The material that may reversibly intercalate and deintercalate lithium ions may include a carbon-based negative electrode active material, for example, crystalline carbon, amorphous carbon, and/or a (e.g., any suitable) combination thereof. For example, the crystalline carbon may include graphite such as non-shaped (e.g., irregularly shaped), sheet-shaped, flake-shaped, sphere-shaped, or fiber-shaped natural graphite and/or artificial graphite, and the amorphous carbon may include soft carbon, hard carbon, mesophase pitch carbon, and/or calcined coke.

The lithium metal alloy may include an alloy of lithium and a metal that is selected from among sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material that may dope and de-dope lithium may include a Si-based negative electrode active material or a Sn-based negative electrode active material. The Si-based negative electrode active material may include silicon, a silicon-carbon composite, SiOₓ (where 0<x≤2), a Si-Q alloy (where Q is an alkali metal, an alkaline earth metal, a Group 13 element, a Group 14 element (except for Si), a Group 15 element, a Group 16 element, a transition metal, a rare-earth element, or a (e.g., any suitable) combination thereof), or a (e.g., any suitable) combination thereof. The Sn-based negative electrode active material may include Sn, SnOₖ (0<k≤2) (e.g., SnO₂), a Sn-based alloy, or a (e.g., any suitable) combination thereof.

The silicon-carbon composite may be a composite of silicon and amorphous carbon (e.g., in a form of particles). According to one or more embodiments, the silicon-carbon composite may have a structure in which the amorphous carbon is coated on a surface of the silicon particle. For example, in one or more embodiments, the silicon-carbon composite may include a secondary particle (core) in which primary silicon particles are assembled, and an amorphous carbon coating layer (shell) on (e.g., positioned on) a surface of the secondary particle. The amorphous carbon may also be positioned between the primary silicon particles, and for example, the primary silicon particles may be coated with the amorphous carbon. The secondary particles may be present dispersed in an amorphous carbon matrix.

In one or more embodiments, the silicon-carbon composite may further include crystalline carbon. For example, the silicon-carbon composite may include a core including crystalline carbon and silicon particles and may also include an amorphous carbon coating layer on (e.g., positioned on) a surface of the core.

In one or more embodiments, the Si-based negative electrode active material and/or the Sn-based negative electrode active material may be used in combination with a carbon-based negative electrode active material.

### Separator 30

Based on type (kind) of the rechargeable lithium battery, the separator 30 may be present between the positive electrode 10 and the negative electrode 20. The separator 30 may include one or more selected from among polyethylene, polypropylene, and polyvinylidene fluoride, or may have a multi-layered separator thereof such as a polyethylene/polypropylene bi-layered separator, a polyethylene/polypropylene/polyethylene tri-layered separator, or a polypropylene/polyethylene/polypropylene tri-layered separator.

The separator 30 may include a porous substrate and a coating layer on (e.g., positioned on) a surface (e.g., one surface or two opposite surfaces) of the porous substrate, and the coating layer may include an organic material, an inorganic material, and/or a (e.g., any suitable) combination thereof.

The porous substrate may be a polymer layer including one selected from among polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymers, polyphenylenesulphide, polyethylene naphthalate, glass fibers, and polytetrafluoroethylene (e.g., Teflon), or may be a copolymer or a mixture including two or more thereof.

The organic material may include a polyvinylidenefluoride-based copolymer or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, and/or a (e.g., any suitable) combination thereof, but embodiments of the present disclosure are not limited thereto.

In one or more embodiments, the organic material and the inorganic material may be present mixed in one coating layer or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may serve as a medium for transmitting ions that participate in an electrochemical reaction of the battery.

The non-aqueous organic solvent may include a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, and/or caprolactone.

The ether-based solvent may include dibutyl ether, tetraglyme, diglyme, dimethoxyethane, 2-methyltetrahydrofuran, 2.5-dimethyltetrahydrofuran, and/or tetrahydrofuran. The ketone-based solvent may include cyclohexanone. The alcohol-based solvent may include ethyl alcohol and/or isopropyl alcohol. The aprotic solvent may include nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane and/or 1,4-dioxolane; and/or sulfolanes.

The non-aqueous organic solvent may be used alone or in a mixture of two or more thereof.

In addition, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a rechargeable lithium battery and plays a role in enabling a basic operation of the rechargeable lithium battery and in promoting the movement of lithium ions between the positive electrode and the negative electrode. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂) (C_{y}F_{2y+1}SO₂) (where x and y are integers of 1 to 20), lithium trifluoromethane sulfonate, lithium tetrafluoroethanesulfonate, lithium difluoro(oxalato)borate (LiDFOB), lithium difluorobis(oxalato)phosphate (LiDFBOP), and lithium bis(oxalato)borate (LiBOB).

The following description will focus on an electrolyte for a rechargeable lithium battery according to one or more embodiments of the present disclosure.

The electrolyte for a rechargeable lithium battery according to one or more embodiments may include a non-aqueous organic solvent, a lithium salt, a first additive represented by Chemical Formula 1, and a second additive represented by Chemical Formula 2.

In one or more embodiments, the non-aqueous organic solvent may be a mixed solvent of ethylene carbonate (EC), ethylmethyl carbonate (EMC), and dimethyl carbonate (DMC). For example, the ethylene carbonate (EC) may be included in an amount of about 10 vol % to about 30 vol % relative to (i.e., based on) a total volume of 100 vol % of the non-aqueous organic solvent. The ethylmethyl carbonate (EMC) may be included in an amount of about 20 vol % to about 70 vol % relative to (i.e., based on) the total volume of 100 vol % of the non-aqueous organic solvent. The dimethyl carbonate (DMC) may be included in an amount of about 20 vol % to about 70 vol % relative to (i.e., based on) the total volume of 100 vol % of the non-aqueous organic solvent.

In one or more embodiments, ethylene carbonate (EC), ethylmethyl carbonate (EMC), and dimethyl carbonate (DMC) may have a volume ratio of 1:a:b (i.e., the volume ratio of EC:EMC:DMC is about 1:a:b), The “a” may be about 1 to about 3, and the “b” may be about 1 to about 3. If (e.g., when) the volume ratio falls within the range above, an electrolyte including the first additive and the second additive may have excellent or suitable solubility in the non-aqueous organic solvent.

The lithium salt may include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), and LiC₄F₉SO₃. In one or more embodiments, the lithium salt may include LiPF₆.

The lithium salt may have a concentration of about 0.1 M to about 2.0 M. For example, in one or more embodiments, the lithium salt may have a concentration of equal to or greater than about 0.5 M or equal to or greater than about 1.0 M. The lithium salt may have a concentration of equal to or less than about 2.0 M, equal to or less than about 1.7 M, or equal to or less than about 1.5 M. For example, in one or more embodiments, the lithium salt may have a concentration of about 1.15 M. If (e.g., when) the lithium salt has a concentration within the range above, the electrolyte may appropriately or suitably maintain its conductivity and viscosity.

### First Additive

The first additive according to one or more embodiments of the present disclosure may be represented by Chemical Formula 1.

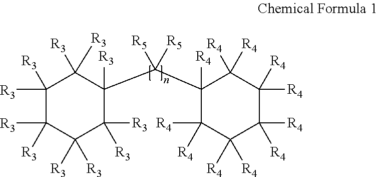

In Chemical Formula 1,
R₁ may be identical to or different from one another and may each independently be hydrogen, a halogen, a C1 to C10 alkyl group, or an isocyanate group, with at least one selected from among R₁(s) being an isocyanate group.
R₂ may be identical to or different from one another and may each independently be hydrogen, a halogen, a C1 to C10 alkyl group, or an isocyanate group, with at least one selected from among R₂(s) being an isocyanate group.
R₃ may be identical to or different from each other and may each independently be hydrogen or a cyclohexyl isocyanate residue.

The subscript n may be an integer of 1 to 10.

In one or more embodiments, the first additive may be represented by Chemical Formula 1-1.

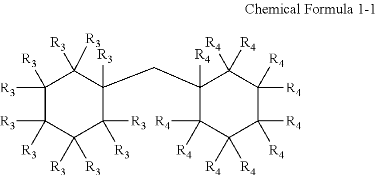

In Chemical Formula 1-1,
R₁ may be identical to or different from one another and may each independently be hydrogen, a halogen, a C1 to C10 alkyl group, or an isocyanate group, at least one selected from among R₁(s) may be an isocyanate group.
R₂ may be identical to or different from one another and may each independently be hydrogen, a halogen, a C1 to C10 alkyl group, or an isocyanate group, at least one selected from among R₂(s) may be an isocyanate group.

In one or more embodiments, the first additive may be represented by Chemical Formula 1-2.

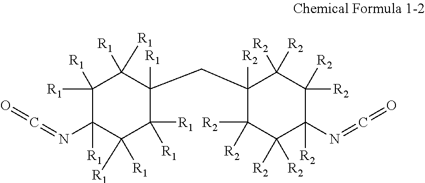

In Chemical Formula 1-2,
R₁ may be identical to or different from one another and may each independently be hydrogen, a halogen, or a C1 to C10 alkyl group.
R₂ may be identical to or different from one another and may each independently be hydrogen, a halogen, or a C1 to C10 alkyl group.

In one or more embodiments, the first additive may be represented by Chemical Formula 1-2-1.

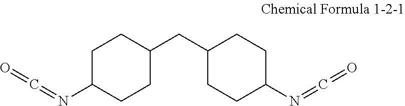 [SMILES: O=C=NC1CCC(CC2CCC(N=C=O)CC2)CC1]

The first additive may be included in an amount of about 0.01 wt % to about 5 wt % relative to (i.e., based on) a total weight of 100 wt % of the electrolyte. For example, in one or more embodiments, the first additive may be included in an amount of equal to or greater than about 0.1 wt %, equal to or greater than about 0.5 wt %, or equal to or greater than about 1 wt % relative to (i.e., based on) the total weight of 100 wt % of the electrolyte. The first additive may be included in an amount of equal to or less than about 3 wt % or equal to or less than about 2 wt % relative to (i.e., based on) the total weight of 100 wt % of the electrolyte. In one or more embodiments, the first additive may be included in an amount of about 0.1 wt % to about 1 wt % relative to (i.e., based on) the total weight of 100 wt % of the electrolyte. If (e.g., when) the first additive is included in an amount of less than about 0.01 wt % relative to the total weight of the electrolyte, there may be a slight effect of solving an issue caused by transition metal ions eluted from the positive electrode. If (e.g., when) the first additive is included in an amount of greater than about 5 wt % relative to the total weight of the electrolyte, there may be a reduction in high-temperature cycle life characteristics during a charge/discharge cycle at high temperatures.

### Second Additive

The second additive according to one or more embodiments of the present disclosure may be represented by Chemical Formula 2.

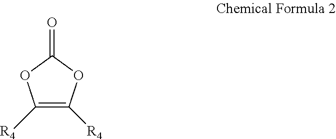

In Chemical Formula 2,
R₄ may be identical to or different from each other and may each independently be hydrogen, a halogen, a cyano (CN) group, a nitro (NO₂) group, or a C1 to C5 alkyl group.

For example, in one or more embodiments, each R₄ in Chemical Formula 2 may be hydrogen. The second additive may be a compound represented by Chemical Formula 2-1. The second additive may be vinylene carbonate.

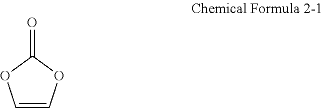

The second additive may be included in an amount of about 0.01 wt % to about 5 wt % relative to (i.e., based on) the total weight of 100 wt % of the electrolyte. For example, in one or more embodiments, the second additive may be included in an amount of equal to or greater than about 0.1 wt %, equal to or greater than about 0.5 wt %, or equal to or greater than about 1 wt % relative to (i.e., based on) the total weight of 100 wt % of the electrolyte. The second additive may be included in an amount of equal to or less than about 3 wt % or equal to or less than about 2 wt % relative to (i.e., based on) the total weight 100 wt % of the electrolyte. In one or more embodiments, the second additive may be included in an amount of about 0.5 wt % to about 1.5 wt % relative to (i.e., based on) the total weight of 100 wt % of the electrolyte. If (e.g., when) the second additive is present in an amount within the range above, it may effectively suppress or reduce a battery resistance increase rate and improve high-temperature swelling characteristics and cycle life characteristics.

If (e.g., when) the second additive is used in combination with the first additive, a synergy effect may occur. For example, if (e.g., when) the first additive and the second additive are used in combination, it may be provide a rechargeable lithium battery with not only improved suppression of resistance increase and gas generation during high-temperature storage but also enhanced high-temperature cycle life characteristics.

According to one or more embodiments, the first additive and the second additive may be included in an amount of about 0.1 wt % to about 10 wt % relative to (e.g., based on) the total weight of 100 wt % of the electrolyte for a rechargeable lithium battery. If (e.g., when) an amount of the first additive and the second additive falls within the range above relative to the total weight of the electrolyte, it may not only maximize or increase effects of mitigating issues of battery resistance increase and gas generation, but also prevent or reduce side reactions caused by excessive additive amount.

In the electrolyte, the first additive and the second additive may be included in a weight ratio of about 5:1 to about 1:3. For example, in one or more embodiments, the first additive and the second additive may be present in a weight ratio of about 2:1 to about 1:3. In one or more embodiments, the first additive and the second additive may be present in a weight ratio of about 1:1 to about 1:3. If (e.g., when) the first additive and the second additive are present in a weight ratio within the range above, it may achieve a rechargeable lithium battery with enhanced suppression of battery internal gas generation and resistance increase and improved cycle life characteristics during high-temperature storage.

### Rechargeable Lithium Battery

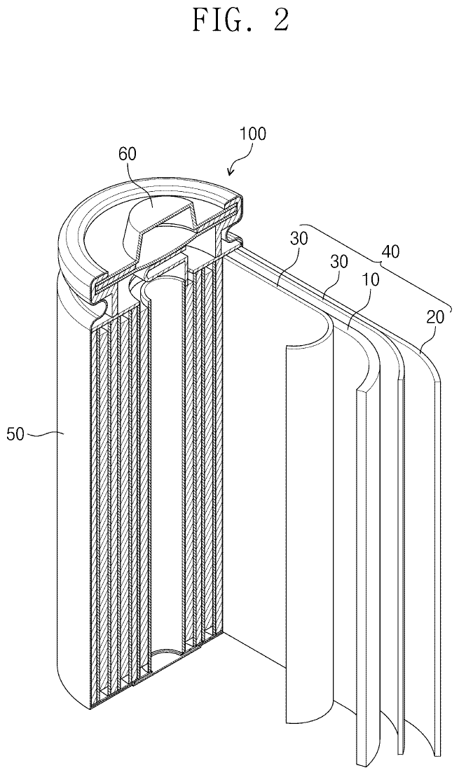

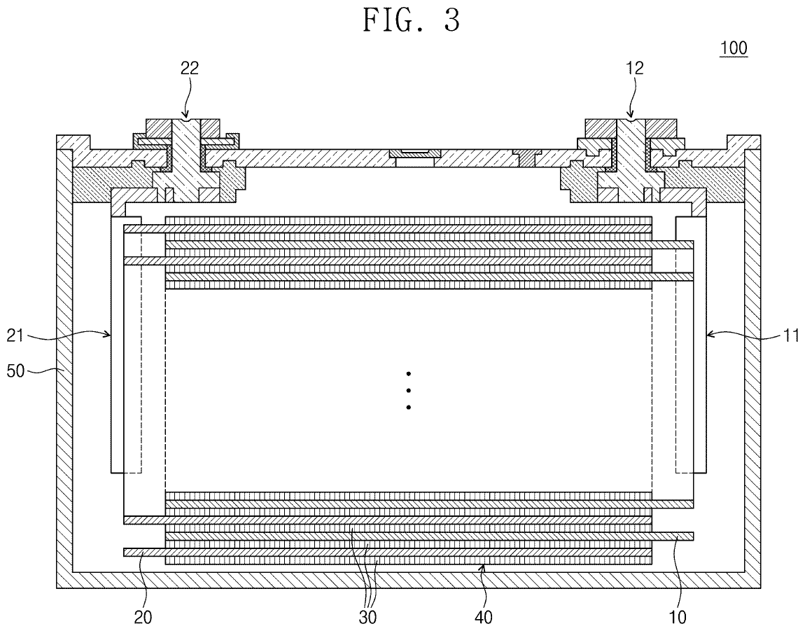

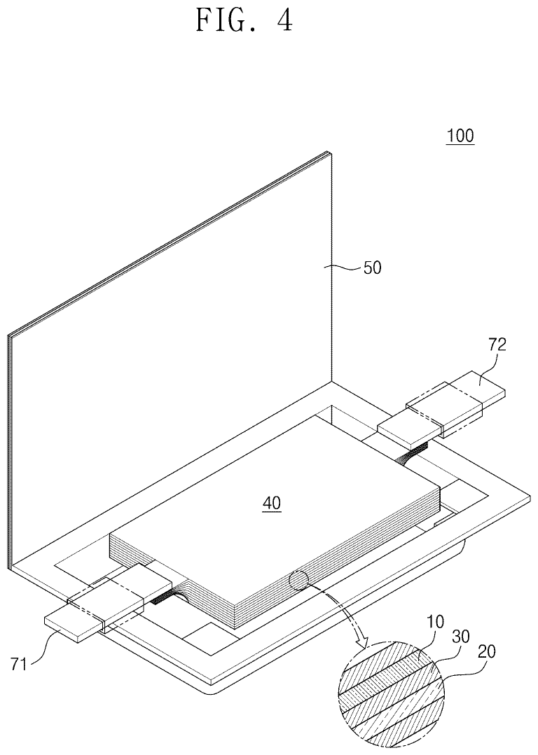

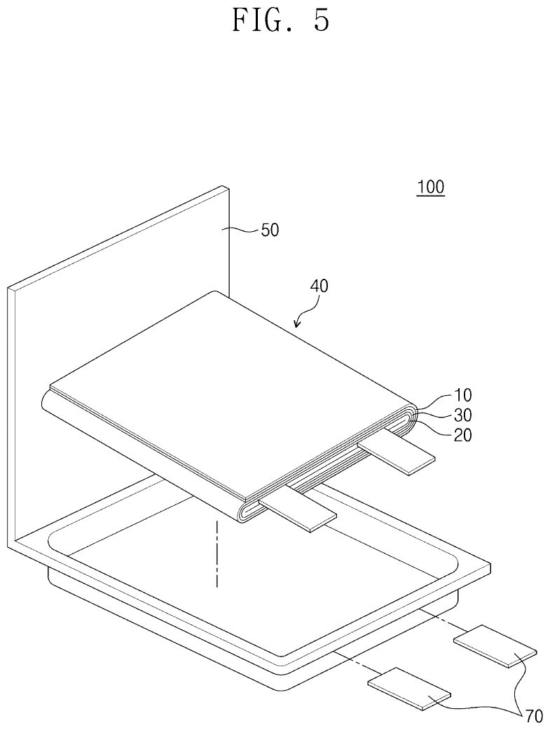

Based on a shape (e.g., external form) of a rechargeable lithium battery, the rechargeable lithium battery may be classified into a cylindrical, prismatic, pouch, or coin type (kind) battery. In FIGS. 2 to 5 each illustrating a simplified diagram showing a rechargeable lithium battery according to one or more embodiments, FIG. 2 shows a cylindrical battery, FIG. 3 shows a prismatic battery, and FIGS. 4 and 5 each show a pouch-type (kind) battery. Referring to FIGS. 2 to 5, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte. In one or more embodiments, the rechargeable lithium battery 100 may include a sealing member 60 that seals the casing 50 as illustrated in FIG. 2. In one or more embodiments, as illustrated in FIG. 3, the rechargeable lithium battery 100 may include a positive electrode lead tab 11, a positive electrode terminal 12, a negative electrode lead tab 21, and a negative electrode terminal 22. In one or more embodiments, as shown in FIGS. 4 and 5, the rechargeable lithium battery 100 may include an electrode tab 70, or a positive electrode tab 71 and a negative electrode tab 72, serving as an electrical path for externally inducing a current generated in the electrode assembly 40.

A rechargeable lithium battery according to one or more embodiments of the present disclosure may include a positive electrode including a positive electrode active material, a negative electrode including a negative electrode active material, and the electrolyte for a rechargeable lithium battery.

The positive electrode active material may include, for example, at least one selected from among lithium-nickel-cobalt-based oxides, cobalt-free nickel-manganese-based oxides, and lithium-iron-phosphate-based compounds.

The electrolyte containing a combination of the first additive and the second additive according to one or more embodiments of the present disclosure may significantly alleviate degradation in cell performance of the rechargeable lithium battery in which at least one selected from among lithium-nickel-cobalt-based oxides, cobalt-free nickel-manganese-based oxides, and lithium-iron-phosphate-based compounds is applied as the positive electrode active material.

The negative electrode active material may be a carbon-based negative electrode active material, a Si-based negative electrode active material, a Sn-based negative electrode active material, or a (e.g., any suitable) combination thereof.

In one or more embodiments, the negative electrode active material may be a silicon-carbon composite containing graphite and silicon nano-particles.

The rechargeable lithium battery according to one or more embodiments of the disclosure may be applied to automotive vehicles, mobile phones, and/or any other electrical devices, but embodiments of the present disclosure are not limited thereto.

The following will describe practical embodiments and comparative examples of the present disclosure. The following embodiments, however, are merely examples, and the disclosure is not limited to example embodiments discussed below.

### Embodiments and Comparatives

An electrolyte and a rechargeable lithium battery were fabricated by the following method.

### Embodiment 1-1

### (1) Preparation of Electrolyte

About 1.15 M of LiPF₆ was dissolved in a non-aqueous organic solvent containing ethylene carbonate (EC), ethylmethyl carbonate (EMC), and dimethyl carbonate (DMC) mixed in a volume ratio of about 20:40:40, and about 0.5 wt % of a first additive and about 0.5 wt % of a second additive were added to prepare an electrolyte, based on the total weight of 100 wt % of the electrolyte.

A material represented by Chemical Formula 1A was used as the first additive. A material represented by Chemical Formula 2A was used as the second additive.

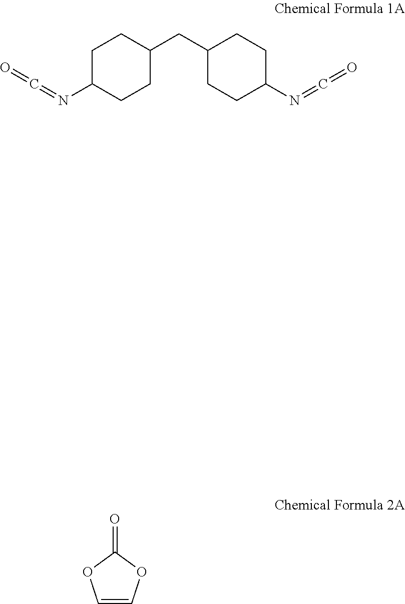 [SMILES: O=C=NC1CCC(CC2CCC(N=C=O)CC2)CC1 ; O=c1occo1]

### (2) Fabrication of Rechargeable Lithium Battery

LiNi_{0.91}Mn_{0.09}O₂ as a positive electrode active material, polyvinylidene fluoride as a binder, and acetylene black as a conductive material were mixed in a weight ratio of 96:3:1, and the mixture was dispersed in N-methyl pyrrolidone to prepare a positive electrode active material slurry.

The positive electrode active material slurry was coated on an Al current collector of 15 μmin thickness, dried at 100° C., and then pressed to manufacture a positive electrode.

Artificial graphite and silicon nano-particles mixed in a weight ratio of 93:7 as a negative electrode active material, styrene butadiene rubber (SBR) as a binder, and carboxymethyl cellulose (CMC) as a thickener were mixed in a weight ratio of 98:1:1, and the mixture was dispersed in distilled water to prepare a negative electrode active material slurry.

The negative electrode active material slurry was coated on a Cu current collector of 10 μmin thickness, dried at 100° C., and then pressed to manufacture a negative electrode.

The positive electrode, the negative electrode, and a polyethylene separator of 25 μmin thickness were assembled to manufacture an electrode assembly, and the electrolyte was introduced to fabricate a rechargeable lithium battery.

### Embodiment 1-2

An electrolyte and a rechargeable lithium battery were each respectively fabricated in substantially the same method as that in Embodiment 1-1, except that the second additive was added in an amount of about 1 wt % when the electrolyte was prepared.

### Embodiment 1-3

An electrolyte and a rechargeable lithium battery were each respectively fabricated in substantially the same method as that in Embodiment 1-1, except that the second additive was added in an amount of about 1.5 wt % when the electrolyte was prepared.

### Embodiment 2-1

An electrolyte and a rechargeable lithium battery were each respectively fabricated in substantially the same method as that in Embodiment 1-1, except that LiNi_{0.91}Co_{0.07}Al_{0.02}O₂ was used as the positive electrode active material.

### Embodiment 2-2

An electrolyte and a rechargeable lithium battery were each respectively fabricated in substantially the same method as that in Embodiment 1-2, except that LiNi_{0.91}Co_{0.07}Al_{0.02}O₂ was used as the positive electrode active material.

### Embodiment 2-3

An electrolyte and a rechargeable lithium battery were each respectively fabricated in substantially the same method as that in Embodiment 1-3, except that LiNi_{0.91}Co_{0.07}Al_{0.02}O₂ was used as the positive electrode active material.

### Embodiment 3-1

An electrolyte and a rechargeable lithium battery were each respectively fabricated in substantially the same method as that in Embodiment 1-1, except that LiFePO₄ was used as the positive electrode active material.

### Embodiment 3-2

An electrolyte and a rechargeable lithium battery were each respectively fabricated in substantially the same method as that in Embodiment 1-2, except that LiFePO₄ was used as the positive electrode active material.

### Embodiment 3-3

An electrolyte and a rechargeable lithium battery were each respectively fabricated in substantially the same method as that in Embodiment 1-3, except that LiFePO₄ was used as the positive electrode active material.

### Comparative 1-1

An electrolyte and a rechargeable lithium battery were each respectively fabricated in substantially the same method as that in Embodiment 1-1, except that neither the first additive nor the second additive was added when the electrolyte was prepared.

### Comparative 1-2

An electrolyte and a rechargeable lithium battery were each respectively fabricated in substantially the same method as that in Embodiment 1-1, except that the second additive is not added when the electrolyte was prepared.

### Comparative 1-3

An electrolyte and a rechargeable lithium battery were each respectively fabricated in substantially the same method as that in Embodiment 1-1, except that the second additive was not added and the first additive was added in an amount of about 1 wt % when the electrolyte was prepared.

### Comparative 2-1

An electrolyte and a rechargeable lithium battery were each respectively fabricated in substantially the same method as that in Comparative 1-1, except that LiNi_{0.91}Co_{0.07}Al_{0.02}O₂ was used as the positive electrode active material.

### Comparative 2-2

An electrolyte and a rechargeable lithium battery were each respectively fabricated in substantially the same method as that in Comparative 1-2, except that LiNi_{0.91}Co_{0.07}Al_{0.02}O₂ was used as the positive electrode active material.

### Comparative 2-3

An electrolyte and a rechargeable lithium battery were each respectively fabricated in substantially the same method as that in Comparative 1-3, except that LiNi_{0.91}Co_{0.07}Al_{0.02}O₂ was used as the positive electrode active material.

### Comparative 3-1

An electrolyte and a rechargeable lithium battery were each respectively fabricated in substantially the same method as that in Comparative 1-1, except that LiFePO₄ was used as the positive electrode active material.

### Comparative 3-2

An electrolyte and a rechargeable lithium battery were each respectively fabricated in substantially the same method as that in Comparative 1-2, except that LiFePO₄ was used as the positive electrode active material.

### Comparative 3-3

An electrolyte and a rechargeable lithium battery were each respectively fabricated in substantially the same method as that in Comparative 1-3, except that LiFePO₄ was used as the positive electrode active material.

### Evaluation 1: High-Temperature Storage Characteristics

For each of the rechargeable lithium batteries according to Embodiments and Comparatives, after initial direct-current internal resistance (DCIR) was measured as ΔV/ΔI (voltage change/current change), the rechargeable lithium battery was allowed to charge its maximum energy state into a full charge state (SOC 100%) and stored in the charged state at a high temperature (60° C.) for 30 days, and then direct-current resistance was measured to calculate a DCIR increase rate (%) according to Equation 1 and the results are listed in Table 1.

$$DCIR increase rate ( \% ) = ( DCIR after 30 days / initial DCIR ) \times 100 \qquad Equation 1$$

TABLE 1

| | | DCIR after high- | |
|---|---|---|---|
| | Initial DCIR | temperature storage | DCIR increase |
| | (mΩ) | (mΩ) | rate (%) |
| Embodiment 1-1 | 13.31 | 14.91 | 112 |
| Embodiment 1-2 | 13.43 | 13.97 | 104 |
| Embodiment 1-3 | 13.62 | 15.39 | 113 |
| Embodiment 2-1 | 11.28 | 12.63 | 112 |
| Embodiment 2-2 | 11.32 | 11.89 | 105 |
| Embodiment 2-3 | 11.67 | 13.30 | 114 |
| Embodiment 3-1 | 19.12 | 21.41 | 112 |
| Embodiment 3-2 | 19.23 | 19.81 | 103 |
| Embodiment 3-3 | 19.36 | 22.26 | 115 |
| Comparative 1-1 | 12.81 | 18.57 | 145 |
| Comparative 1-2 | 13.22 | 16.26 | 123 |
| Comparative 1-3 | 13.45 | 16.27 | 121 |
| Comparative 2-1 | 11.29 | 15.24 | 135 |
| Comparative 2-2 | 11.15 | 13.27 | 119 |
| Comparative 2-3 | 11.50 | 13.80 | 120 |
| Comparative 3-1 | 18.72 | 29.20 | 156 |
| Comparative 3-2 | 19.02 | 25.49 | 134 |
| Comparative 3-3 | 19.13 | 25.25 | 132 |

Referring to Table 1, it may be ascertained that there is a dramatic increase in DCIR after high-temperature storage in the cases in each of which an electrolyte is utilized to which neither the first additive nor the second additive is added (Comparatives 1-1, 2-1, and 3-1), and in the cases in each of which an electrolyte is utilized to which the second additive is not added and in which an amount of the first additive is different (Comparatives 1-2, 1-3, 2-2, 2-3, 3-2, and 3-3).

In contrast, it may be ascertained that there is an improvement in DCIR increase rate in the cases in each of which an electrolyte is utilized to which both (e.g., simultaneously) of the first additive and the second additive are added and in which an amount of the second additive is different (Embodiments 1-1 to 1-3, 2-1 to 2-3, and 3-1 to 3-3). In other words, for Embodiments 1-1 to 1-3, 2-1 to 2-3, and 3-1 to 3-3, in each of which an electrolyte is utilized to which both (e.g., simultaneously) of the first additive and the second additive are added and in which an amount of the second additive is different, the rechargeable lithium battery exhibits a reduced DCIR increase rate after the fully charged rechargeable lithium battery is left at high temperatures.

For example, the electrolyte containing a combination of the first additive and the second additive may effectively improve high-temperature storage characteristics of the rechargeable lithium battery in which at least one selected from among lithium-nickel-cobalt-based oxides, cobalt-free nickel-manganese-based oxides, and lithium-iron-phosphate-based compounds is applied as the positive electrode active material.

### Evaluation 2: High-Temperature Cycle Life Characteristics

Each of the rechargeable lithium batteries according to Embodiments and Comparatives was allowed to evaluate high-temperature charge/discharge characteristics. Each of the rechargeable lithium batteries was charged and discharged at 45° C. for 200 cycles under the condition of 0.5 C charge (CC/CV, 4.45 V, 0.025 C cut-off) and 0.5 C discharge (CC, 2.5 V cut-off).

A capacity retention rate was calculated according to Equation 2. The results are listed in Table 2.

$$Capacity rentention rate ( \% ) = ( discharge capacity after 200 cycles / initial discharge capacity ) \times 100 \qquad Equation 2$$

TABLE 2

| | 200 cycles at 45° C. |
|---|---|
| | Capacity retention rate (%) |
| Embodiment 1-1 | 94.6 |
| Embodiment 1-2 | 95.2 |
| Embodiment 1-3 | 93.6 |
| Embodiment 2-1 | 93.1 |
| Embodiment 2-2 | 94.8 |
| Embodiment 2-3 | 93.4 |
| Embodiment 3-1 | 96.3 |
| Embodiment 3-2 | 97.7 |
| Embodiment 3-3 | 95.9 |
| Comparative 1-1 | 85.3 |
| Comparative 1-2 | 90.1 |
| Comparative 1-3 | 90.6 |
| Comparative 2-1 | 88.1 |
| Comparative 2-2 | 91.2 |
| Comparative 2-3 | 91.3 |
| Comparative 3-1 | 93.3 |
| Comparative 3-2 | 93.7 |
| Comparative 3-3 | 94.2 |

Referring to Table 2, it may be ascertained that, comparing with each other the cases in each of which cobalt-free nickel-manganese-based oxide is applied as the positive electrode active material, each of the rechargeable lithium batteries according to Embodiments 1-1 to 1-3 has a capacity retention rate superior to that of each of the rechargeable lithium batteries according to Comparatives 1-1 to 1-3.

In addition, it may be ascertained that, comparing with each other the cases in each of which lithium-nickel-cobalt-based oxide is applied as the positive electrode active material, each of the rechargeable lithium batteries according to Embodiments 2-1 to 2-3 has a capacity retention rate superior to that of each of the rechargeable lithium batteries according to Comparatives 2-1 to 2-3.

Moreover, it may be ascertained that, comparing with each other the cases in each of which lithium-iron-phosphate-based compound is applied as the positive electrode active material, each of the rechargeable lithium batteries according to Embodiments 3-1 to 3-3 has a capacity retention rate superior to that of each of the rechargeable lithium batteries according to Comparatives 3-1 to 3-3.

Therefore, it may be ascertained that the electrolyte containing a combination of the first additive and the second additive may improve high-temperature cycle life characteristics in accordance with a charge/discharge cycle of the rechargeable lithium battery in which at least one selected from among lithium-nickel-cobalt-based oxides, cobalt-free nickel-manganese-based oxides, and lithium-iron-phosphate-based compounds is applied as the positive electrode active material.

### Evaluation 3: Gas Generation at High-Temperature Storage

Each of the rechargeable lithium batteries fabricated in Embodiments and Comparatives was stored at 60° C. for 14 days, and then refinery gas analysis (RGA) was utilized to measure a gas generation amount (mL). The results are listed in Table 3.

TABLE 3

| | After stored at 60° C. for 14 days |
|---|---|
| | Gas generation amount (mL) |
| Embodiment 1-1 | 0.039 |
| Embodiment 1-2 | 0.026 |
| Embodiment 1-3 | 0.040 |
| Embodiment 2-1 | 0.045 |
| Embodiment 2-2 | 0.028 |
| Embodiment 2-3 | 0.043 |
| Embodiment 3-1 | 0.024 |
| Embodiment 3-2 | 0.018 |
| Embodiment 3-3 | 0.022 |
| Comparative 1-1 | 0.087 |
| Comparative 1-2 | 0.056 |
| Comparative 1-3 | 0.048 |
| Comparative 2-1 | 0.091 |
| Comparative 2-2 | 0.056 |
| Comparative 2-3 | 0.058 |
| Comparative 3-1 | 0.046 |
| Comparative 3-2 | 0.028 |
| Comparative 3-3 | 0.027 |

Referring to Table 3, it may be ascertained that, comparing with each other the cases in which cobalt-free nickel-manganese-based oxide is applied as the positive electrode active material, each of the rechargeable lithium batteries according to Embodiments 1-1 to 1-3 has a less amount of gas generation when left at high temperatures than that of each of the rechargeable lithium batteries according to Comparatives 1-1 to 1-3.

In addition, it may be ascertained that, comparing with each other the cases in each of which lithium-nickel-cobalt-based oxide is applied as the positive electrode active material, each of the rechargeable lithium batteries according to Embodiments 2-1 to 2-3 has a less amount of gas generation when left at high temperatures than that of each of the rechargeable lithium batteries according to Comparatives 2-1 to 2-3.

Moreover, it may be ascertained that, comparing with each other the cases in each of which lithium-iron-phosphate-based compound is applied as the positive electrode active material, each of the rechargeable lithium batteries according to Embodiments 3-1 to 3-3 has a less amount of gas generation when left at high temperatures than that of each of the rechargeable lithium batteries according to Comparatives 3-1 to 3-3.

Therefore, it may be ascertained that the electrolyte containing a combination of the first additive and the second additive may effectively suppress or reduce the gas generation of the rechargeable lithium battery in which at least one selected from among lithium-nickel-cobalt-based oxides, cobalt-free nickel-manganese-based oxides, and lithium-iron-phosphate-based compounds is applied as the positive electrode active material.

According to one or more embodiments of the present disclosure, it may achieve a rechargeable lithium battery with increased high-temperature cycle life characteristics, superior high-temperature storage characteristics, excellent or suitable suppression of battery internal gas generation at high-temperature storage, and improved battery stability. In other words, by employing the electrolyte of one or more embodiments, the rechargeable lithium battery may exhibit increased high-temperature cycle life characteristics, superior high-temperature storage characteristics, excellent or suitable suppression of battery internal gas generation at high-temperature storage, and improved battery stability.

In the present disclosure, expressions such as “at least one of,” “one of,” and “selected from,” when preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. The “/” utilized herein may be interpreted as “and” or as “or” depending on the situation.

In the context of the present disclosure and unless otherwise defined, the terms “use,” “using,” and “used” may be considered synonymous with the terms “utilize,” “utilizing,” and “utilized,” respectively.

In present disclosure, The term “Group” as utilized herein refers to a group of the Periodic Table of Elements according to the 1 to 18 grouping system of the International Union of Pure and Applied Chemistry (“IUPAC”).

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A battery manufacturing device, a battery management system (BMS) device, and/or any other relevant devices or components according to embodiments of the present invention described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

While this disclosure has been described in connection with what is presently considered to be example embodiments, it is to be understood that the disclosure is not limited to the disclosed embodiments and is intended to cover one or more suitable modifications and equivalent arrangements included within the spirit and scope of the appended claims and equivalents thereof, and therefore the aforementioned embodiments should be understood to be explanatory but not limiting this disclosure in any way.

What is claimed is:

1. An electrolyte, comprising:
a non-aqueous organic solvent;
a lithium salt;
a first additive represented by Chemical Formula 1; and
a second additive represented by Chemical Formula 2, 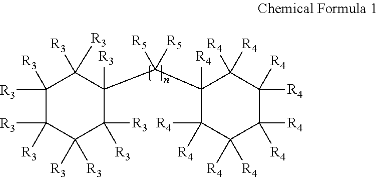
wherein, in Chemical Formula 1,
each R₁ is identical to or different from one another and is independently hydrogen, a halogen, a C1 to C10 alkyl group, or an isocyanate group, at least one selected from among R₁(s) being an isocyanate group,
each R₂ is identical to or different from one another and is independently hydrogen, halogen, a C1 to C10 alkyl group, or an isocyanate group, wherein at least one of R₂ is an isocyanate group,
each R₃ is identical to or different from each other and is independently hydrogen or a cyclohexyl isocyanate residue, and
n is an integer of 1 to 10, 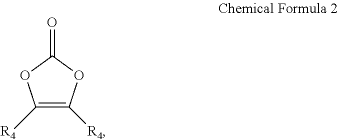
wherein, in Chemical Formula 2,
each R₄ is identical to or different from each other and is independently hydrogen, a halogen, a cyano group, a nitro group, or a C1 to C5 alkyl group, and
wherein the electrolyte is for a rechargeable lithium battery.

2. The electrolyte as claimed in claim 1, wherein the first additive is represented by Chemical Formula 1-1, 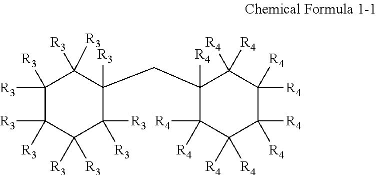
in Chemical Formula 1-1,
each R₁ being identical to or different from one another and being independently hydrogen, a halogen, a C1 to C10 alkyl group, or an isocyanate group, at least one selected from among R₁(s) being an isocyanate group, and
each R₂ being identical to or different from one another and being independently hydrogen, a halogen, a C1 to C10 alkyl group, or an isocyanate group, at least one selected from among R₂(s) being an isocyanate group.

3. The electrolyte as claimed in claim 1, wherein the first additive is represented by Chemical Formula 1-2, 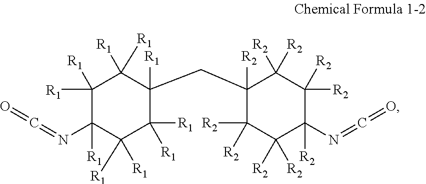
in Chemical Formula 1-2,
each R₁ being identical to or different from one another and being independently hydrogen, a halogen, or a C1 to C10 alkyl group, and
each R₂ being identical to or different from one another and being independently hydrogen, a halogen, or a C1 to C10 alkyl group.

4. The electrolyte as claimed in claim 1, wherein each R₄ in Chemical Formula 2 is hydrogen.

5. The electrolyte as claimed in claim 1, wherein the first additive is in an amount of about 0.05 wt % to about 5 wt % based on a total weight of 100 wt % of the electrolyte.

6. The electrolyte as claimed in claim 1, wherein the first additive is in an amount of about 0.1 wt % to about 1 wt % based on a total weight of 100 wt % of the electrolyte.

7. The electrolyte as claimed in claim 1, wherein the second additive is in an amount of about 0.05 wt % to about 5 wt % based on a total weight of 100 wt % of the electrolyte.

8. The electrolyte as claimed in claim 1, wherein the second additive is in an amount of about 0.5 wt % to about 1.5 wt % based on a total weight of 100 wt % of the electrolyte.

9. The electrolyte as claimed in claim 1, wherein the first additive and the second additive are in an amount of about 0.1 wt % to about 10 wt % based on a total weight of 100 wt % of the electrolyte.

10. The electrolyte as claimed in claim 1, wherein the first additive and the second additive are in a weight ratio of about 5:1 to about 1:3.

11. The electrolyte as claimed in claim 1, wherein the non-aqueous organic solvent comprises a carbonate-based solvent.

12. The electrolyte as claimed in claim 11, wherein the carbonate-based solvent comprises ethylene carbonate, ethylmethyl carbonate, and dimethyl carbonate.

13. The electrolyte as claimed in claim 12, wherein ethylene carbonate, ethylmethyl carbonate, and dimethyl carbonate have a volume ratio of 1:a:b,
wherein a is about 1 to about 3, and
wherein b is about 1 to about 3.

14. The electrolyte as claimed in claim 1, wherein the lithium salt comprises LiPF₆.

15. The electrolyte as claimed in claim 1, wherein a concentration of the lithium salt is in a range of about 0.1 M to about 2.0 M.

16. A rechargeable lithium battery, comprising:
a positive electrode that comprises a positive electrode active material;
a negative electrode that comprises a negative electrode active material; and
the electrolyte as claimed in claim 1.

17. The rechargeable lithium battery as claimed in claim 16, wherein the positive electrode active material comprises at least one selected from among lithium-nickel-cobalt-based oxides, cobalt-free nickel-manganese-based oxides, and lithium-iron-phosphate-based compounds.

18. The rechargeable lithium battery as claimed in claim 16, wherein the negative electrode active material comprises a carbon-based negative electrode active material, a Si-based negative electrode active material, a Sn-based negative electrode active material, or a combination thereof.

19. The rechargeable lithium battery as claimed in claim 18, wherein the Si-based negative electrode active material is a silicon-carbon composite.
